(19) United States
(12) Patent Application Publication
(10) Pub. No.: US 2005/0234765 A1
(43) Pub. Date: Oct. 20, 2005

(54) Method for evaluating computer-network based marketing tactics

(76) Inventors: Marc A. Blumberg, Dallas, TX (US); Ian M. Wolfman, Dallas, TX (US)

Correspondence Address: Daniel H. Golub, 1701 Market Street, Philadelphia, PA, 19103, US

(21) Appl. No.: 10/880,207

(22) Filed: Jun. 29, 2004

Related U.S. Application Data
(60) Provisional application No. 60/562,595, filed on Apr. 15, 2004.

(51) Int. Cl. G06F 17/60

(52) U.S. Cl. 705/10

(57) ABSTRACT

A method for evaluating one or more computer-network based marketing tactics relating to a product. Target audience information, product lifecycle information, and marketing objective information relating to the product is received. Based on the target audience information, the product lifecycle information, and the marketing objective information, at least one marketing tactic relating to the product is automatically identified. A list comprising the marketing tactic is presented to the user. A selection of at least one of the presented marketing tactics is received from the user.

### CROSS REFERENCE TO RELATED APPLICATIONS

The present application claims priority to U.S. Provisional Patent Application No. 60/562,595, filed Apr. 15, 2004, entitled “Method for Evaluating Computer-Network Based Marketing Tactics”, the contents of which is hereby incorporated herein in its entirety by reference.

### BACKGROUND OF THE INVENTION

1. Field of the Invention

The present invention relates to development of online marketing strategies.

2. Background of the Invention

Interactive marketing is complex. Brand marketers interested in creating an interactive marketing program can choose from a variety of tactics, such as Web development, online media, couponing programs, email marketing, and search engine marketing, to name a few. Brand marketers tend to struggle with putting together interactive marketing strategies. They are familiar with offline marketing tactics, such as TV and print marketing. In the relatively new realm of interactive marketing, however, marketers struggle to assemble strategies that make sense. Thus, there exists a need for an effective and efficient way to allow brand marketers develop an online marketing strategy.

### SUMMARY OF THE INVENTION

The present invention is directed to a method for evaluating one or more computer-network based marketing tactics relating to a product. Target audience information, product lifecycle information, and marketing objective information relating to the product is received. Based on the target audience information, the product lifecycle information, and the marketing objective information, at least one marketing tactic relating to the product is automatically identified. A list of the marketing tactic(s) identified is presented to the user. A selection of at least one of the presented marketing tactics is received from the user.

The present invention is also directed to a method for facilitating a user's evaluation of a plurality of computer-network based marketing tactics relating to a product. Each of the marketing tactics are categorized as a foundation site, an action driver or a reach driver. The appropriateness of each of the marketing tactics for (i) a plurality of stages in a lifecycle of the product and (ii) a plurality of marketing objectives for the product, is determined. The user is presented with a compilation comprising a description of each categorized marketing tactic and the determination of appropriateness for each marketing tactic to facilitate the user's evaluation of the marketing tactics.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide further understanding of the invention and are incorporated in and constitute a part of this specification, illustrate embodiments of the invention and together with the description serve to explain the principles of the invention.

In the drawings:

FIG. 1 provides a listing of exemplary target audience profiles used in connection with one embodiment of the present invention;

FIG. 2 provides a listing of exemplary execution tactic briefs used in connection with one embodiment of the present invention;

FIG. 3 provides a screen of an exemplary interface used in connection with the present invention;

FIG. 4 provides a screen of an exemplary interface used in connection with the present invention;

FIG. 5 provides a screen of an exemplary interface used in connection with the present invention;

FIG. 6 provides a screen of an exemplary interface used in connection with the present invention;

FIG. 7 provides a screen of an exemplary interface used in connection with the present invention;

FIG. 8 provides a screen of an exemplary interface used in connection with the present invention;

FIG. 9 provides a screen of an exemplary interface used in connection with the present invention;

FIG. 10 provides a screen of an exemplary interface used in connection with the present invention;

FIG. 11A is a flow chart illustrating a preferred embodiment of a method of the present invention;

FIG. 11B is a flow chart illustrating a preferred embodiment of a method of the present invention; and

FIG. 12 is a flow chart illustrating a preferred embodiment of a method of the present invention.

### DETAILED DESCRIPTION OF THE PREFERRED EMBODIMENTS

Reference will now be made in detail to the preferred embodiments of the present invention, examples of which are illustrated in the accompanying drawings. Wherever possible, the same reference numbers will be used throughout the drawings to refer to the same or like parts.

The present invention relates to an interactive, strategy development tool for online marketing. The invention provides marketers with a variety insights on interactive marketing and the depth of content to fully understand the choices available to them. Its interactive design allows marketers to create a truly customized program tied directly to their own business situation. In using the invention, brand marketers provide a series of inputs, such as details on their target audience, the lifecycle stage of their product, and the objectives of their interactive marketing program. The invention then recommends which online tactics will best address the given marketing opportunity. The approach implemented in accordance with a preferred embodiment of the present invention involves evaluating target audiences; prioritizing marketing objectives; evaluating the tactic toolkit; selecting the tactics; identifying key measures; documenting a strategic plan; and validating and executing the plan, although it will be understood to one skilled in the art that one or more of the foregoing may be altered from that described herein in accordance with the present invention. These steps are discussed in more detail below.

Thus, the present invention provides a structured strategy development process for interactive marketing. Target Audience Profiles (TAPs) may be used in connection with the invention, which provide detailed information on the size and the habits of Internet users from various demographic profiles. In addition, Execution Tactic Briefs (ETBs) may be used in connection with the invention, which provide details on marketing approaches and include overall descriptions, usage recommendations, descriptions of the value of the tactic to the brand and the target audience, recommended success measures and metrics, cost ranges, technology implementation guidelines, and risk scenarios and avoidance suggestions. In some embodiments, a Strategy Planning Worksheet may be used, where users can select the tools and budgets that best fit their needs. A Strategy Planning Document may be provided, which outlines the plan that the user has selected. Users are led through the process of leveraging all of the tools above to create a unique plan.

TAPs provide valuable segmentation information about the consumers and professionals in the United States. Three types of TAPs, discussed herein by way of example, are consumer segmentation, practice areas and patient status. These TAPs relate to development of online marketing strategies for a pharmaceutical drug or other medical product. Other types of TAPs can be used in accordance with the present invention and would be tailored in accordance with the product or service that is the subject of the online marketing strategy.

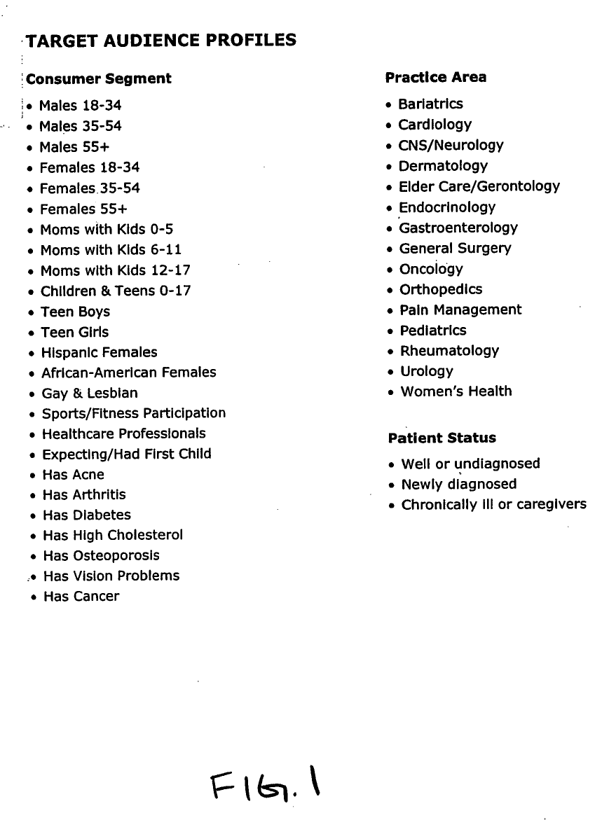

A consumer segmentation profile provides rich information derived from various public sources and may include information such as the total United States population; United States population by household income and race; top online activities by reach and indexed against general population; and top content sites by reach and indexed against general population. A practice area profile provides information such as conditions associated with the practice area; total number of physicians in the practice area and number online; total number of consumers with related disease or conditions and number online; consumer audience considerations, which examines areas such as searching behavior, community support, online purchases, level of involvement, and sensitivity to disease or condition (each area may be further explored as related to a patient's status of being well or undiagnosed, newly diagnosed, or chronically ill or a caregiver); and advocacy and association groups (e.g., lists of web sites the target audiences are likely to visit). Patient status profiles may include information on patients in the following states of diagnosis: well or undiagnosed; newly diagnosed; and chronically ill or caregivers. A patient's status often influences their behavior online. These profiles provide an overview of the typical behavior pattern of a patient's searching, likelihood to participate in an online community, online purchase behavior and level of involvement within each stage. An exemplary listing of TAPs is provided in FIG. 1. A sample TAP is provided in Appendix A.

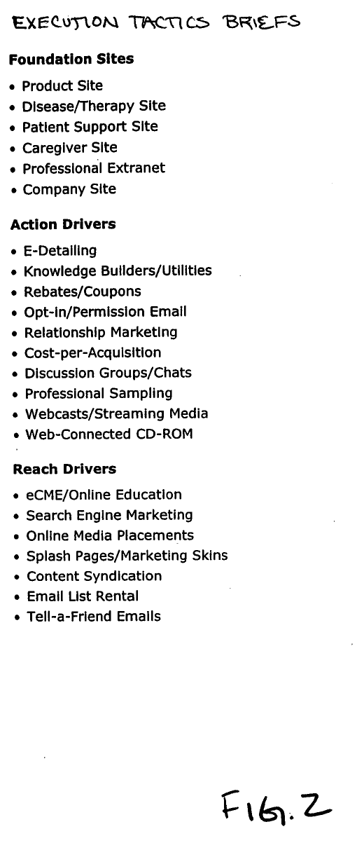

ETBs include a depth of information related to each tactic covered by the present invention. Each ETB provides a core understanding of a tactic to support the evaluation of whether it is appropriate to support an interactive marketing strategy. In the preferred embodiment, the ETBs are categorized into three main groups to ensure that the user chooses an appropriate mix of tactics to achieve his/her objectives. The first group is foundation sites, which are typically employed as a support mechanism for online programs or as an extension of offline programs. A second group is action drivers. These are typically employed to engage target audiences to move along the value continuum from awareness to conversion to loyalty. The last group is reach drivers. Reach drivers are typically employed to ensure messaging is delivered to target audiences in context or when in a need state. A listing of exemplary ETBs is provided in FIG. 2. A sample ETB is provided in Appendix B.

In a preferred embodiment, each ETB includes the following information to aid the user in the evaluation process:
Description—high level overview of the tactic
Selection criteria—things to consider when evaluating the appropriateness of the tactic
Appropriate usage scenarios—scenarios of when it is appropriate to use the tactic
Weighting factors—value of the tactic against awareness, conversion, and compliance objectives
Types of execution—appropriate ways to implement the tactic
Brand value—value to the brand in using the specific tactic
Target audience value—value the target audience will receive upon execution of the tactic
Recommended metrics—how to measure the impact of the tactic
Success considerations—ways to ensure the tactic is successful
Development timeline—average time it takes to develop the tactic
Cost considerations—various costs associated with the tactic
Technology considerations—important technology issues to consider
Maintenance considerations—ongoing maintenance that should be expected
Legal and privacy considerations—legal and privacy issues to consider
Risk mitigation—risks associated with the tactic and ways to mitigate the risks
Brand responsibilities—what the brand can do to ensure success
Related tactics—other tactics that are related to the tactic

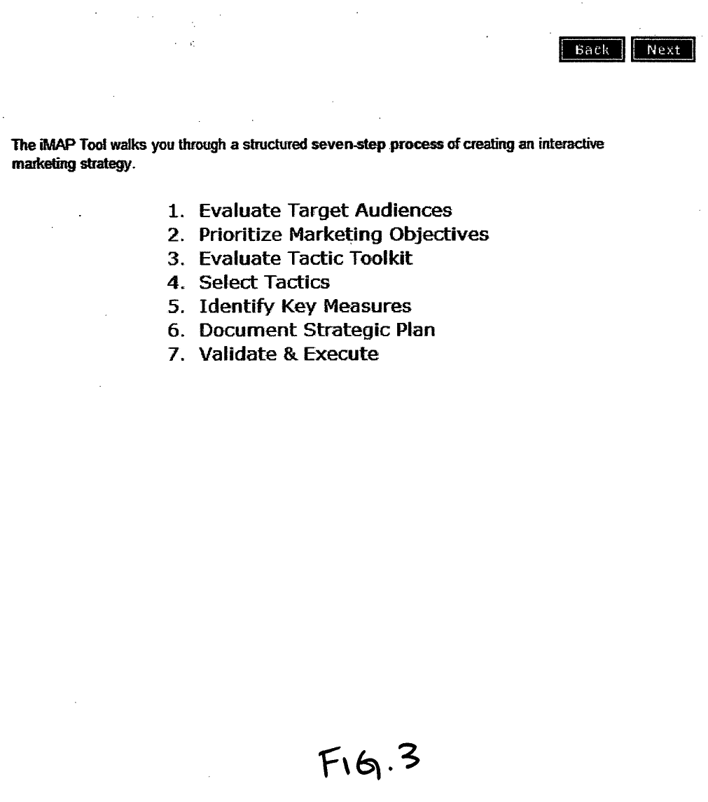

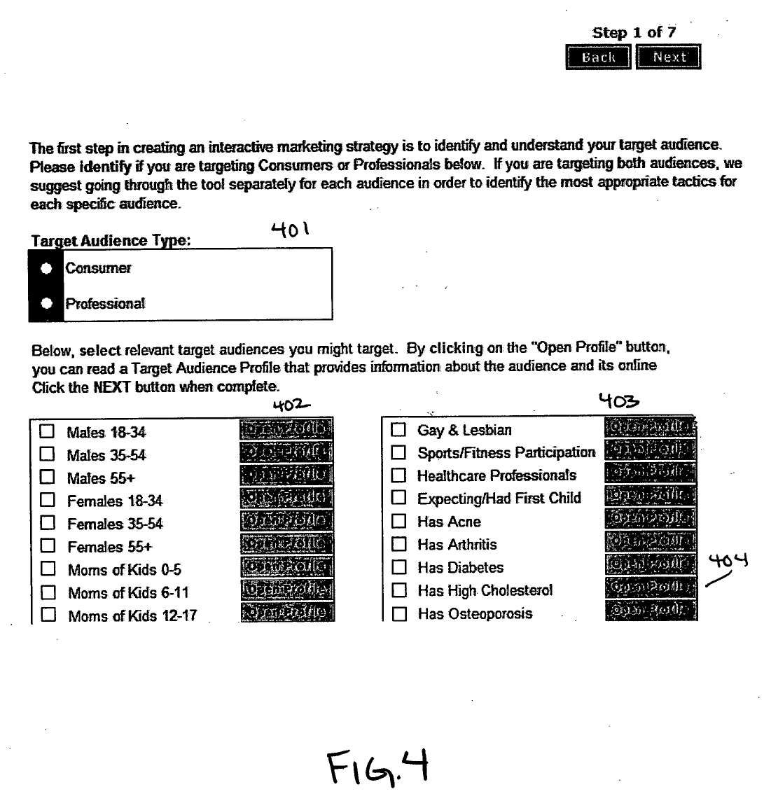

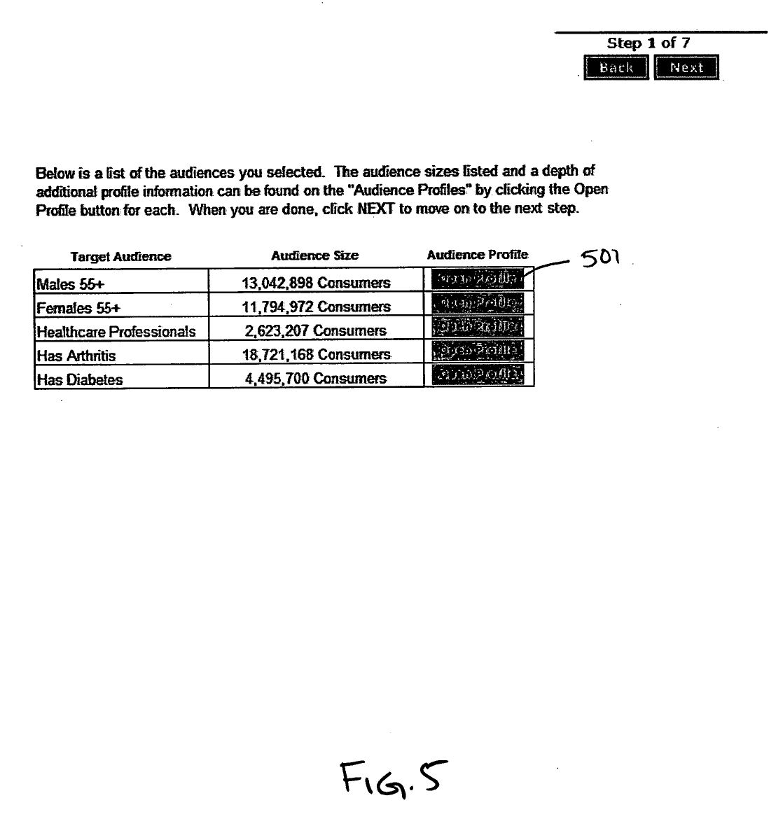

Referring to FIGS. 3 through 10, exemplary screen shots illustrating the inventive tool are shown. With reference to FIG. 3, the seven steps carried out in accordance with a preferred embodiment of the present invention are listed. In the first step, illustrated in FIG. 4, the user identifies his/her target audience in box 401. For example, the user may be targeting consumers or professionals or both. If targeting both, it is recommended that the user go through the interactive process once for each. The user then selects the relevant target audiences in boxes 402 and 403. In order to assist the user in selecting a target audience, the user may review the TAP for any of the target audiences displayed in boxes 402 and 403 by clicking on any one of the “Open Profile” buttons 404. With reference to FIG. 5, the audiences selected by the user are shown. By clicking on any of the “Audience Profile” buttons 501, the user can obtain information regarding the audience size and additional profile information.

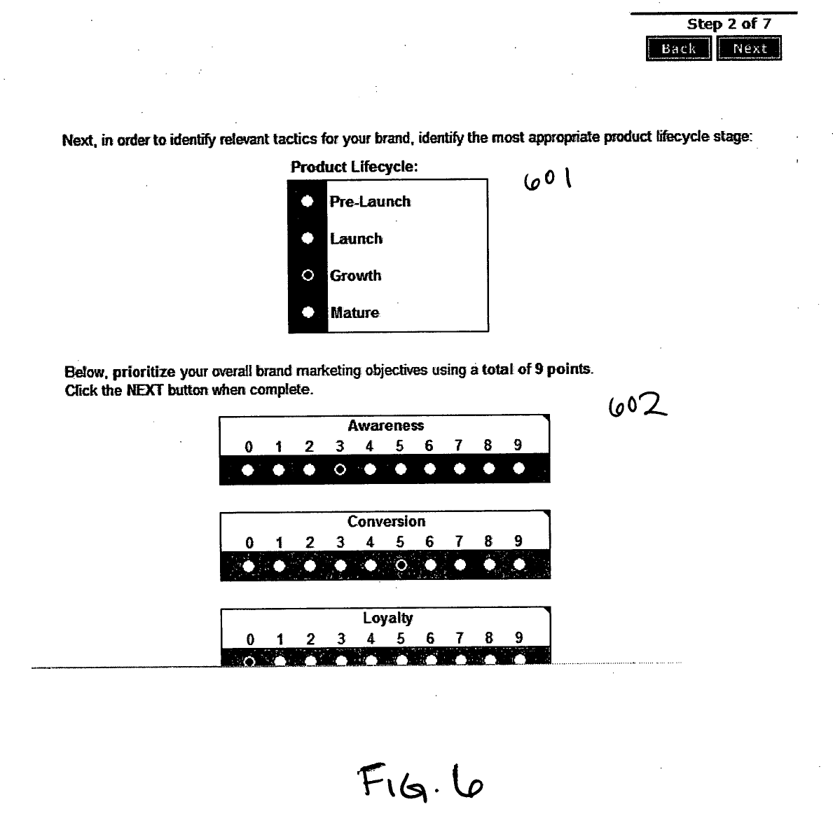

Referring now to FIG. 6, in the next step, the user identifies the most appropriate product lifecycle stage in box 601, such as pre-launch, launch, growth, and mature. In box 602, the user prioritizes his/her overall brand marketing objectives for the product. For example, the user may indicate which objectives (e.g., awareness, conversion, loyalty) are important and the level of their importance, which may be indicated by a numbered scale.

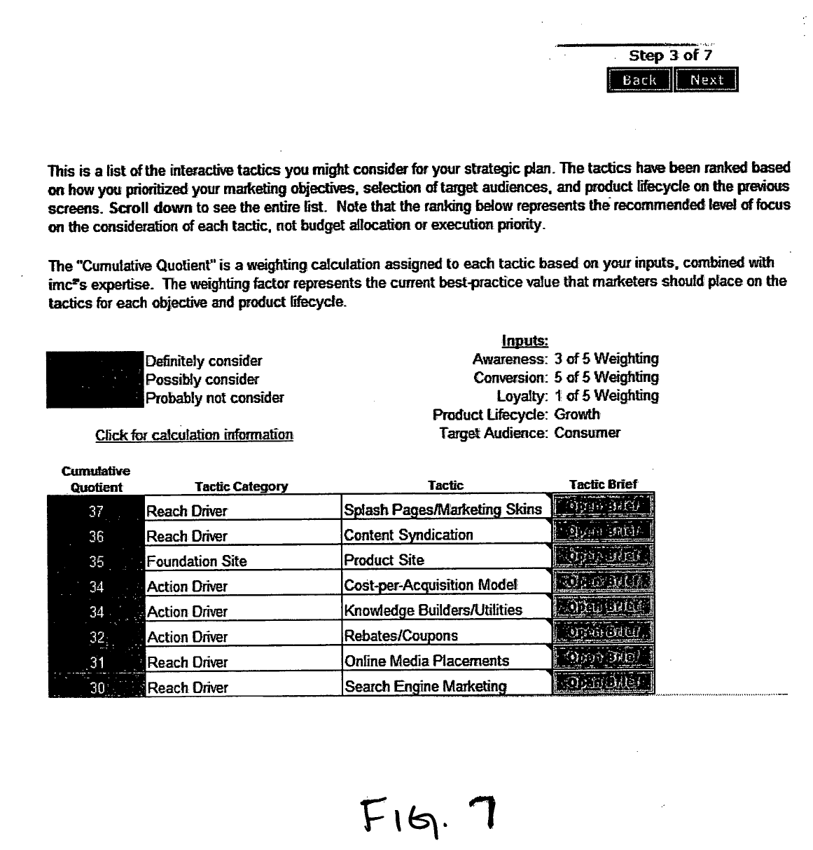

Referring to FIG. 7, a number of tactics are presented to the user based on the user's selection of the target audience, marketing objectives and prioritization, and product lifecycle information. The tactics presented to the user may be ranked, in the preferred embodiment, in accordance with the recommended level of focus that should be directed to each. A cumulative quotient is provided, which is the result of a calculation performed based on various weightings assigned to each tactic and the user's inputs.

For example, for the product web site tactic, a zero weighting may be assigned for a product that is pre-launch for all marketing objectives. A weighting of 4 may be given for a product that is in a launch stage for the marketing objectives of awareness and conversion, and a weighting of 2 given for the marketing objective of loyalty. For a product in a growth stage, a weighting of 4 may be given for the marketing objectives of awareness and conversion, and a weighting of 3 for the marketing objective of loyalty. For a mature product, a weighting of 4 may be given for the marketing objective of awareness, and a weighting of 3 may be given for the marketing objectives of conversion and loyalty. Weightings are assigned for each tactic in this manner. In this example, for a user who indicates that his product is in a growth stage, and assigns awareness a priority of 3, conversion a priority of 4, and loyalty a priority of 2, the cumulative quotient for the product site tactic will be 34 (i.e., (3×4)+(4×4)+(2×3)).

The weightings may be the same whether the target audience is professionals or consumers. Other tactics, such as a professional extranet, may not be applicable if the target audience is consumers. Similarly, tactics such as patient support sites and discussion groups/chats may not be applicable if the target audience is professionals.

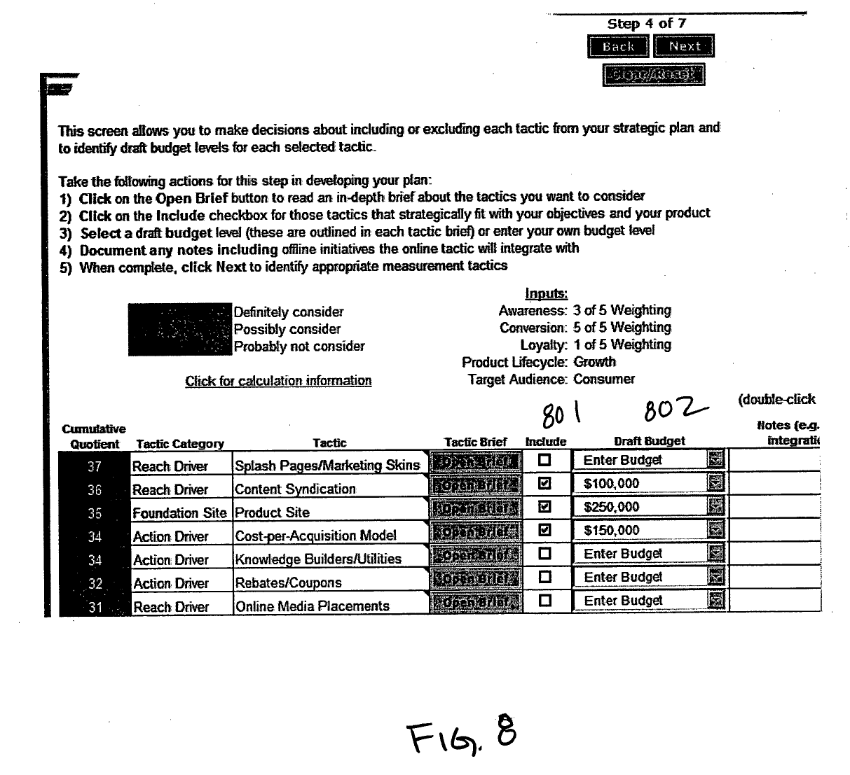

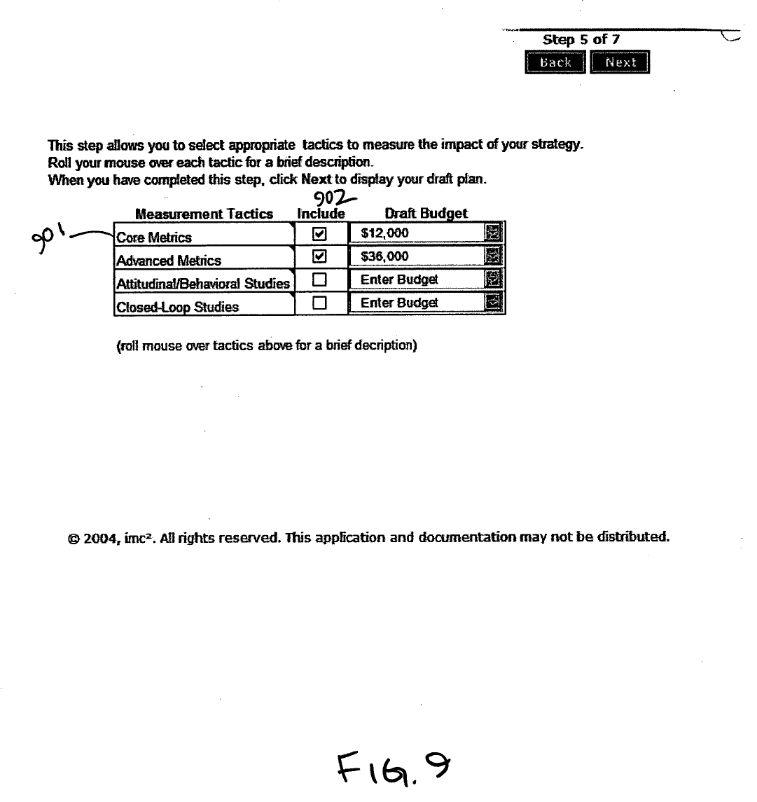

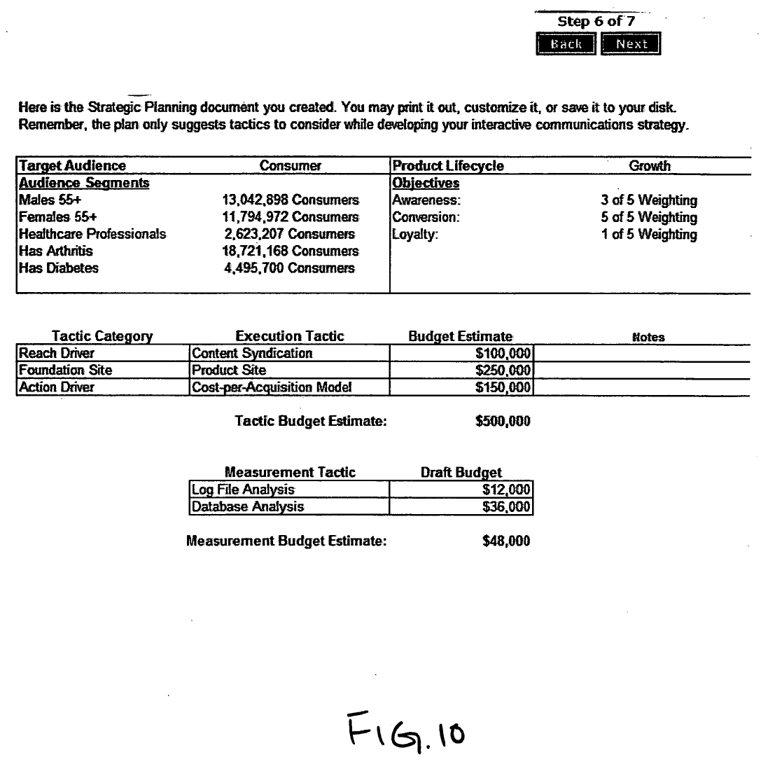

Referring to FIG. 8, the user may include or exclude tactics from his/her plan (using include button 801) and identify draft budget levels (using box 802) for each selected tactic. Referring to FIG. 9, the user may roll his/her mouse over each measurement tactic 901 to measure the impact of the strategies selected. Doing so will present to the user the ETB associated with each measurement tactic 901. At this point, the user may further determine which tactics to include using include button 902. Referring to FIG. 10, the strategic planning document resulting from the use of the interactive tool is presented.

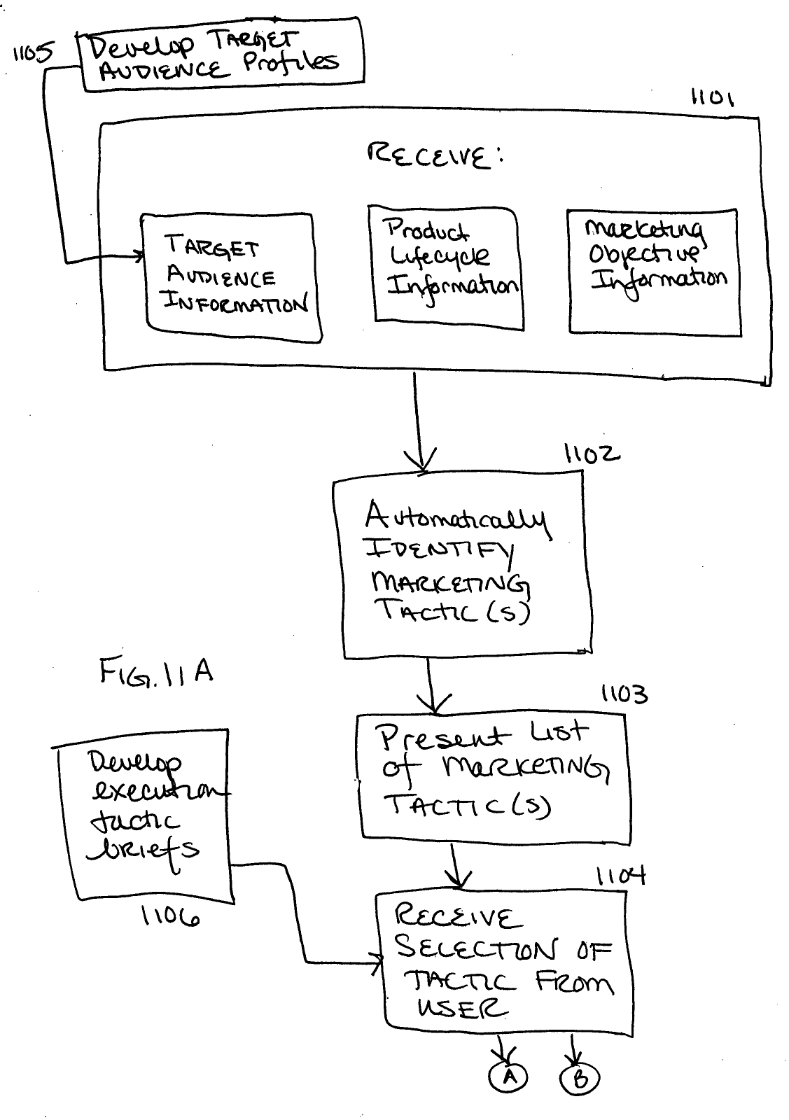

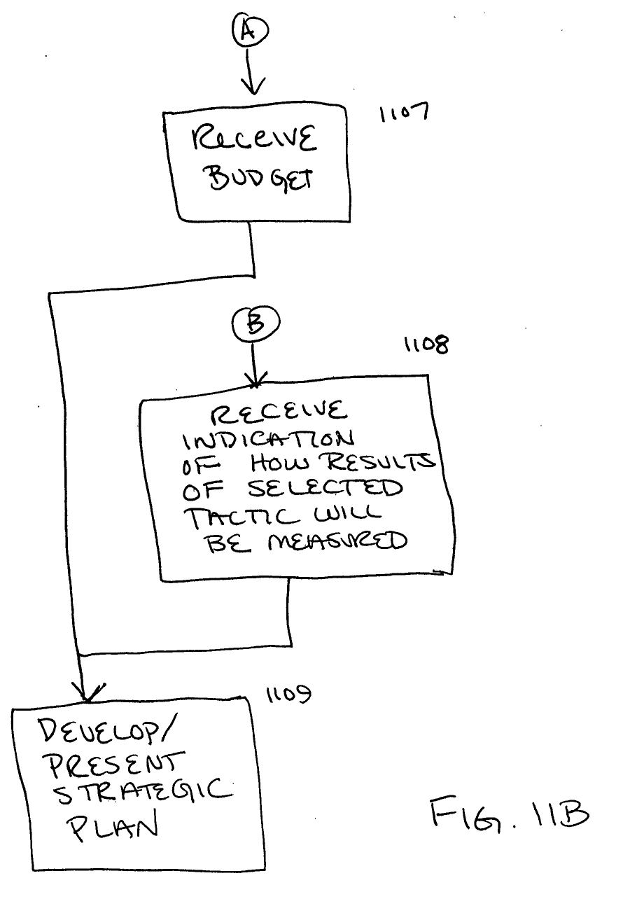

With reference to FIG. 11A, a method for evaluating one or more computer-network based marketing tactics relating to a product is illustrated. User target audience information, product lifecycle information, and marketing objective information relating to the product is received in step 1101. In some embodiments, target audience profiles are developed, in step 1105, to assist the user in providing the target audience information. Based on the target audience information, the product lifecycle information, and the marketing objective information, at least one marketing tactic relating to the product is automatically identified in step 1102. A list comprising the marketing tactic is presented to the user in step 1103. A selection of at least one of the presented marketing tactics is received from the user in step 1104. In some embodiments, in step 1105, execution tactic briefs are developed in step 1106 to assist the user in selecting a marketing tactic.

With reference to FIG. 11B, in some embodiments, in step 1107, a budget for executing the selecting marketed tactic is received from the user. In other embodiments, in step 1108, an indication is received from the user as to how the results of the selected marketing tactics will be measured, as shown in FIG. 9. In step 1109, a strategic plan is developed and presented to the user.

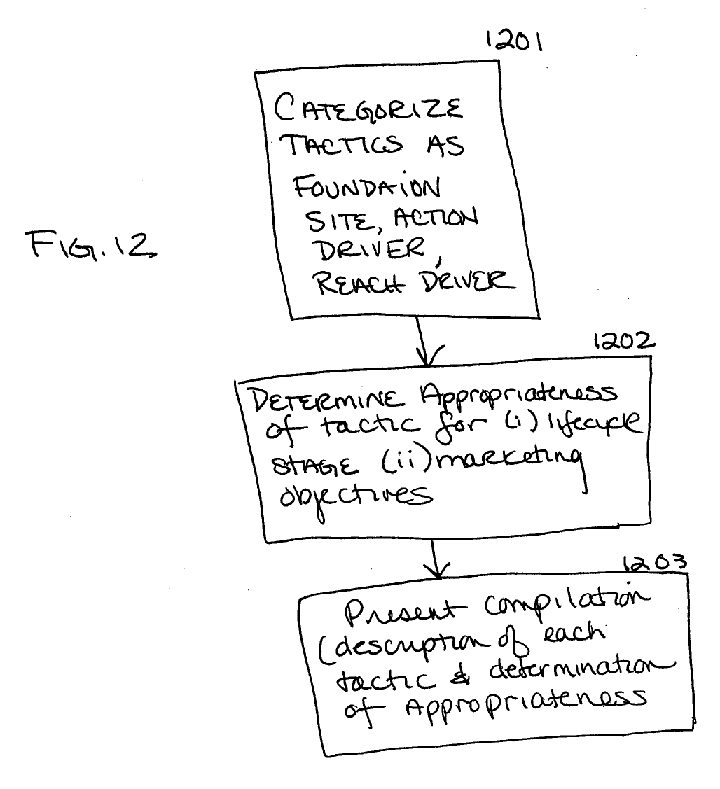

With reference to FIG. 12, a method for facilitating a user's evaluation of a plurality of computer-network based marketing tactics relating to a product is illustrated. Each of the plurality of marketing tactics are categorized as a foundation site, an action driver or a reach driver in step 1201. The appropriateness of each of the plurality of marketing tactics for (i) a plurality of stages in a lifecycle of the product and (ii) a plurality of marketing objectives for the product, is determined in step 1202. The user is presented with a compilation comprising a description of each categorized marketing tactic and the determination of appropriateness for each marketing tactic to facilitate the user's evaluation of the marketing tactics in step 1203.

1. A method for evaluating one or more computer-network based marketing tactics relating to a product, comprising:
receiving from a user target audience information, product lifecycle information, and marketing objective information relating to the product;
based on the target audience information, the product lifecycle information, and the marketing objective information, automatically identifying at least one marketing tactic relating to the product;
presenting to the user a list comprising the at least one marketing tactic relating to the product; and
receiving from the user a selection of at least one of the presented marketing tactics.

2. The method of claim 1 wherein the list of marketing tactics is prioritized.

3. The method of claim 1, further comprising:
developing target audience profiles to assist the user in providing the target audience information.

4. The method of claim 3 wherein the target audience profiles comprise target audience computer network usage information.

5. The method of claim 1, further comprising:
developing one or more execution tactic briefs to assist the user in selecting at least one of the presented marketing tactics.

6. The method of claim 1 wherein the product lifecycle information comprises an indication of one of a plurality of lifecycle stages for the product.

7. The method of claim 6 wherein the lifecycle stages comprise pre-launch, launch, growth and mature.

8. The method of claim 1 wherein the marketing objective information comprises an indication of at least one of awareness, conversion and loyalty.

9. The method of claim 1 further comprising:
receiving from the user a selection of a budget for executing the selected marketing tactic.

10. The method of claim 1 further comprising:
receiving from the user an indication of how results of the selected marketing tactic will be measured.

11. The method of claim 9 or 10 further comprising:
developing and presenting to the user a strategic plan to implement the selected marketing tactic.

12. A method for facilitating a user's evaluation of a plurality of computer-network based marketing tactics relating to a product comprising:
(A) categorizing each of the plurality of marketing tactics as a foundation site, an action driver or a reach driver;
(B) determining an appropriateness of each of the plurality of marketing tactics for (i) a plurality of stages in a lifecycle of the product and (ii) a plurality of marketing objectives for the product; and
(C) presenting to the user a compilation comprising a description of each categorized marketing tactic and the determination of appropriateness for each marketing tactic to facilitate the user's evaluation of the marketing tactics.
